(19) United States
(12) Patent Application Publication
(10) Pub. No.: US 2026/0097348 A1
(43) Pub. Date: Apr. 9, 2026

(54) FLAT-FILTER FILTER ELEMENT HAVING AT LEAST TWO FILTER-MATERIAL BODIES, FILTER SYSTEM, AND USE OF A FLAT-FILTER FILTER ELEMENT

(71) Applicant: MANN+HUMMEL GmbH, Ludwigsburg (DE)

(72) Inventor: Daniel SCHMID, Sachsenheim (DE)

(21) Appl. No.: 19/406,459

(22) Filed: Dec. 2, 2025

Related U.S. Application Data
(63) Continuation of application No. PCT/EP2024/063500, filed on May 16, 2024.

(30) Foreign Application Priority Data
Jun. 6, 2023 (DE) 10 2023 114 807.9

(51) Int. Cl. B01D 46/64; B01D 46/00; B01D 46/52

(52) U.S. Cl. CPC B01D 46/64; B01D 46/0013; B01D 46/0036; B01D 46/521; B01D 2265/04; B01D 2267/40; B01D 2271/022

(57) ABSTRACT

A flat-filter filter element for filtering fluid has at least two areal filter medium bodies arranged axially adjacent to each other and arranged to be flowed through axially by the fluid sequentially. The filter medium bodies each have an outer circumference. A common circumferential lateral strip frames the filter medium bodies at their respective outer circumference. The filter medium bodies include a downstream filter medium body and an upstream filter medium body. The common lateral strip has a protrusion section that extends from the downstream filter medium body axially to the upstream filter medium body. A circumferential molded element is arranged at the upstream filter medium body. The common lateral strip is embedded at least partially in the circumferential molded element. The filter element is arranged in a filter housing of a filter system and the circumferential molded element seals first and second housing parts of the filter housing.

### CROSS-REFERENCE TO RELATED APPLICATIONS

This application is a continuation application of international application No. PCT/EP2024/063500 having an international filing date of May 16, 2024, and designating the United States, the international application claiming a priority date of June 6, 2023, based on prior filed German patent application No. 10 2023 114 807.9, the entire contents of the aforesaid applications being incorporated herein by reference.

### BACKGROUND

The invention concerns a flat-filter filter element for filtering a fluid, for example for filtering air, for a filter system, for example for an air filter system of a fuel cell system, as well as a filter system for filtering a fluid, for example for filtering air, for example of a fuel cell system, with such a flat-filter filter element, and a use of a flat filter element in a filter system.

Fuel cell systems often require a particle filter and an adsorption filter in order to filter particles as well as harmful gases out of the intake air. The filter elements are often configured as flat filters, for example, but other filter element shapes are also available.

DE 10 2009 016 739 A1 discloses a housing for filtering the intake air of a fuel cell, including a housing bottom part and a housing top part which together delimit a chamber. The chamber is divided by at least one filter element into a raw air chamber and a clean air chamber. The housing bottom part as well as the housing top part each have assigned thereto an air passage socket for guiding intake air into the chamber or out of the chamber. In this context, the filter element is at least partially embedded in a seal material.

DE 10 2011 017 444 A1 discloses an easy-change filter module to be flange-mounted to a wall of a housing which receives a fuel cell. The easy-change filter module includes a filter element with a filter medium. The filter element includes a seal which interacts in the manner of a lock-and-key connection with the housing.

EP 3 520 878 B1 discloses a filter element for filtering interior air with at least three filter layers, wherein the filter layers are arranged in a frame and the frame is assembled of extruded profile strips. In this context, the first filter layer is configured as a prefilter, the second filter layer as a fine filter, and the third filter layer as an adsorption filter. In the frame, a region is provided for each filter layer. Furthermore, each profile strip includes between second filter layer and third filter layer a projecting step which serves for separating the second filter layer from the third filter layer in the region of the frame.

US 2015/0273985 A1 discloses an interior air filter element which, as an exchangeable filter element for an interior air filter for a driver cabin of agricultural and work machines, for example with sprinkling and spraying devices for plant protection or fertilizers, may be installed in a vehicle-fixed filter housing. The interior air filter element includes a prefilter layer, an adsorption filter layer, a fine filter layer, for example for separating aerosols, as well as a filter element frame. The filter element frame determines by its geometry a flow direction along which the intake air flows through the aforementioned filter layers. The filter element frame includes two regions. In the first region of the filter element frame, a first effective cross section surface is provided with regard to the flow of the intake air through the filter layers. A corresponding second effective cross section surface is provided in the second region. The first region and the second region are separated by a circumferential seal. The circumferential seal serves for separation of the raw side of the interior air filter element from the clean side when the interior air filter element is installed in the filter housing of the interior air filter. The first region is arranged upstream in regard to the seal, the second region is arranged downstream in regard to the seal. In this context, the second effective cross section surface area amounts to only a fraction of the first effective cross section surface area. The filter layers are fastened by means of adhesive spots in the filter element frame.

US 2021/0276401 A1 discloses a vehicle interior filter system which includes a filter module and a further filter module that is arranged downstream of the filter module. Each filter module includes one or several filter elements. The filter elements of the filter module are folded at a first fold distance and include a gas filter element. The filter elements of the further filter module are folded at a second fold distance and include a particle filter element. In this context, the second fold distance is smaller than the first fold distance. The filter elements of a filter module are arranged in a frame, respectively. The frame is sealed by a seal against a module housing in which the filter module is arranged. The module housing, when installed in a filter housing, is sealed by an end face seal in relation to the filter housing.

### Summary

It is an object of the invention to provide a service-friendly and cost-efficient flat-filter filter element with at least two filter medium bodies for filtering a fluid, for example for filtering air, for a filter system, for example for an air filter system of a fuel cell system.

A further object is to provide a filter system for filtering a fluid, for example for filtering air, for example of a fuel cell system, with such a service-friendly and cost-efficient filter element.

A further object is to provide a use of a flat-filter filter element in a filter system.

The aforementioned object is solved according to an aspect of the invention by a flat-filter filter element for filtering a fluid, for example for filtering air, for a filter system, for example for an air filter system of a fuel cell system, including an array of at least two areal filter medium bodies arranged adjacent to each other in an axial direction and arranged so as to be flowed through sequentially by the fluid in the axial direction, wherein the filter medium bodies at their respective outer circumference are framed by a common circumferential lateral strip, wherein the common lateral strip extends with a protrusion section from the downstream filter medium body in axial direction to the upstream filter medium body, and wherein the common lateral strip is embedded at the outermost upstream filter medium body at least partially in a circumferential molded element.

The further object is solved by a filter system for filtering a fluid, for example for filtering air, for example of a fuel cell system, including a filter housing with a fluid inlet and a fluid outlet and including at least one flat-filter filter element which is arranged between the fluid inlet and the fluid outlet, wherein a seal surface of a first housing part of the filter housing contacts the molded element of the flat-filter filter element, and wherein a housing wall of the second housing part is pressed seal-tightly against the molded element at a side of the molded element facing away from the seal surface.

The further object is solved by a use of a flat-filter filter element in a filter system for filtering a fluid, for example for filtering air, for example for an air filter system of a fuel cell system.

Embodiments and advantages of the invention are apparent from the further description and the accompanying drawings.

According to an aspect of the invention, a flat-filter filter element for filtering a fluid, for example for filtering air, for a filter system, for example for an air filter system of a fuel cell system, is proposed, including an array of at least two areal filter medium bodies arranged adjacent to each other in an axial direction and arranged so as to be flowed through sequentially by the fluid in the axial direction. The filter medium bodies are framed at their respective outer circumference by a common circumferential lateral strip. The common lateral strip extends with a protrusion section from the downstream filter medium body in axial direction to the upstream filter medium body. In this context, the common lateral strip is embedded at the outermost upstream filter medium body at least partially in a circumferential molded element.

The proposed filter element may be used for filtering the intake air of fuel cells. An adsorption of harmful substances and a particle filtration may be realized beneficially in different filter medium bodies, respectively. The two filter medium bodies are connected to each other by the common lateral strip. The common lateral strip extends with a protrusion section from the downstream filter medium body in axial direction to the upstream filter medium body. In this context, the protrusion section overlaps an outer circumference of the upstream filter medium body at least partially. The common lateral strip may be connected, for example, to the filter medium bodies by means of a hot melt.

The common lateral strip, for example, may be configured of a nonwoven material, for example a filter nonwoven, filter fabric or laid filter material. The nonwoven material of the lateral strip may include for example a reduced air permeability compared to a filter medium of the filter medium body and/or a higher bending stiffness compared to a filter medium of the filter medium body.

For example in case of smaller filter medium bodies, the connection by means of the common lateral strip is sufficient in order to ensure a stable unit of the filter element which is also robust enough for handling during installation and exchange of the filter element.

A circumferential molded element is molded around the upstream outer edge of the outermost upstream filter medium body and the lateral strip and fixes the connection of the filter medium bodies and the lateral strip and, in addition, is configured as a seal element for sealing between a raw side and a clean side as well as for sealing in relation to the housing parts of the filter housing.

The upstream filter medium body is closer to the inflow side of the filter element than the downstream filter medium body which is closer to the outflow side of the filter element.

The molded element may be produced by means of a plastic material molding process or plastic material foaming process in a suitable mold, for example, from the molding material polyurethane (PUR). The molding material may be configured as a hard foam or soft foam.

A foaming process and a mold tool are sufficient in order to produce with them the filter element.

The molded element configured as a seal may be designed such that a counter force of the housing parts provides the sealing action. The molded element may then be compressed between the housing parts.

In the proposed flat-filter filter element, both filter medium bodies for the two filtration stages are thus arranged in the form of flat filter medium bodies one after another in a flow direction.

The two filter medium bodies may be configured as folded bellows, wound body, loose fill (primarily for adsorption of harmful gases), coated honeycomb body (primarily for adsorption of harmful gases) or combinations thereof. The height of the filter medium bodies in axial direction may be designed differently. The flow through the filter element is such that the filter medium body embodied as a particle filter is always flowed through first. A sealing action of the filter element in relation to the filter housing may be realized in axial direction.

Particles as well as harmful gases may be filtered out of the intake air in this manner, for example, in fuel cell systems.

The installation space which is available may thus be utilized better. This results in advantages in relation to adsorption capability, dust capacity, degree of separation, and pressure loss of the filter element.

According to an embodiment of the filter element, the common lateral strip may extend up to an upstream end of the upstream filter medium body and be embedded there in the molded element. In this manner, the filter medium bodies are stably fixedly connected and additionally tied to the molded element by means of the lateral strip.

According to an embodiment of the filter element, the upstream filter medium body at its upstream end may be embedded also in the molded element. A fixed connection between filter medium body and molded element may be achieved in this way.

According to an embodiment of the filter element, the outermost downstream arranged one of the filter medium bodies and the outermost upstream arranged one of the filter medium bodies may be arranged at least partially in axial direction radially inside of a circumferential frame element.

The filter element may thus include a frame element as a carrier for the two filter medium bodies. The two filter medium bodies connected by the common lateral strip may be fixedly connected in this context by means of the molded element to the frame element. The frame element provides additional stability for example for larger filter elements.

The frame element may be produced by means of a conventional plastic material injection molding process in which liquefied plastic material is injected under pressure into a mold and hardened.

According to an embodiment of the filter element, the outermost upstream filter medium body at one of its outer edges, for example its upstream outer edge, may be connected by means of the circumferential molded element to the frame element. In this way, a fixed connection to the frame element may be realized which, at the same time, may be configured as a seal element for a sealing action in the filter housing.

According to an embodiment of the filter element, the frame element may include at its upstream end an outwardly folded collar. In this context, the collar may be for example embedded in the molded element. In this way, a fixed interlocking of the molded element with the frame element results. Even filter medium bodies with higher weight and larger expansion are imparted in this way with sufficient stability for mounting in the filter housing.

According to an embodiment of the filter element, the frame element may be configured like a pot and, at its downstream end, a reinforcement element in the form of a reinforcement grid forms a bottom of the pot-like frame element. For example, the frame element and the reinforcement element may be embodied together as one piece. Especially in case of very large areally expansive filter elements, the reinforcement element may contribute to a reinforcement of the entire filter element. In addition, the two filter medium bodies may be supported in this way against the flow pressure of the fluid to be filtered.

According to an embodiment of the filter element, the frame element, at least in the region of the molded element, may include gaps in its circumference for interlocking with the molded element. Due to the gaps for interlocking with the molding material of the molded element, a reliable and permanent connection between the molded elements and the frame element may be realized.

According to an embodiment of the filter element, the outermost downstream filter medium body may include an additional filter layer at its outflow side. In this way, for example an escape of adsorption particles from the downstream filter medium body due to the fluid flow may be prevented. As embodiments for the additional filter layer, filter media on the basis of cellulose fibers and/or synthetic fibers, for example nonwoven materials and/or filter membranes, are conceivable.

The filter medium bodies may be configured as folded filter bellows and/or as wound body and/or as loose fill and/or as coated honeycomb body.

According to an embodiment of the filter element, the outermost upstream filter medium body may be configured as a particle filter. As an alternative or in addition, the outermost downstream filter medium body may be configured as an adsorption filter. The particle filter may be configured, for example, of cellulose. The adsorption filter may be configured as active carbon filter and/or as ion exchanger.

According to an embodiment of the filter element, the molded element may be configured as a seal element for sealing, for example in axial direction, between a raw side and a clean side when the filter element is installed as intended in a filter housing of the filter system. For example, the molded element may be arranged radially outside of the at least two filter medium bodies and may be configured for sealing between a first housing part and a second housing part of the filter housing of the filter system. In this manner, the molded element may fulfill several functions and may be configured to connect the two filter medium bodies as well as to seal the filter element in relation to the filter housing. Due to the arrangement outside of the two filter medium bodies, the molded element may be compressed effectively between the two housing parts and thus ensure the sealing action between the raw side and the clean side of the filter system as well as the sealing action in relation to the environment.

According to an embodiment of the filter element, at least one of the two filter medium bodies may be configured as a folded filter bellows, wherein end face edges of folds of the at least one of the two filter medium bodies may be sealed by an end face edge bonding. In this context, the end face edge bonding may be embedded at least partially in the molded element. In this manner, a reliable lateral sealing action of the filter medium body by means of the end face edge bonding and tying to the molded element are ensured.

According to a further aspect of the invention, a filter system for filtering a fluid, for example for filtering air, for example of a fuel cell system, is proposed, including a filter housing with a fluid inlet and a fluid outlet and including at least one flat-filter filter element which is arranged between the fluid inlet and the fluid outlet. In this context, a seal surface of a first housing part of the filter housing contacts the molded element of the flat-filter filter element and a housing wall of a second housing part of the filter housing is seal-tightly pressed against the molded element at a side of the molded element facing away from the seal surface.

The proposed filter system may be used for filtering the intake air of fuel cells. The adsorption and particle filtration may be realized beneficially in different filter medium bodies. The two filter medium bodies of the filter element are connected to each other by a common lateral strip. The common lateral strip extends with a protrusion section from the downstream filter medium body in axial direction to the upstream filter medium body. In this context, the protrusion section overlaps an outer circumference of the upstream filter medium body at least partially.

A circumferential molded element is molded around the upstream outer edge of the outermost upstream filter medium body and the lateral strip and fixes the connection of filter medium bodies and lateral strip and, in addition, is configured as a seal element for sealing between a raw side and a clean side of the filter system as well as for sealing in relation to the housing parts of the filter housing.

The molded element may be produced by means of a plastic material molding process or plastic material foaming process in a suitable mold, for example, from the molding material polyurethane (PUR). The molding material may be configured as a hard foam or soft foam.

The molded element configured as a seal element may be designed such that a counter force of the housing parts provides the sealing action. The molded element may then be compressed between the housing parts.

The two filter medium bodies may be configured as folded bellows, wound body, loose fill (primarily for adsorption of harmful gases), coated honeycomb body (primarily for adsorption of harmful gases) or combinations thereof. The height of the filter medium bodies in axial direction may be designed differently. The flow through the filter element is such that the filter medium body embodied as a particle filter is always flowed through first. A sealing action of the filter element in relation to the filter housing may be realized in axial direction.

Particles as well as harmful gases may thus be filtered out of the intake air, for example, in fuel cell systems.

The installation space which is available may thus be utilized better. This results in advantages in relation to adsorption capability, dust capacity, degree of separation, and pressure loss of the filter system.

According to an embodiment of the filter system, the filter element may include a circumferential frame element with a collar extending in a lateral direction which is embedded in the molded element. In this context, the collar with the molded element may be compressed between the seal surface and the end of the housing wall.

The filter element may thus include a frame element as a carrier for the two filter medium bodies. The two filter medium bodies connected by the common lateral strip may be fixedly connected in this context by means of the molded element to the frame element. The frame element provides additional stability for example for larger filter elements.

The molded element may be designed such that a counter force of the housing parts provides for the sealing action. The seal may then be compressed between frame element and the housing parts. Due to embedding of the collar of the frame element, the molded element exhibits an increased stiffness and the filter element is fixed in the filter housing in a stable manner.

According to a further aspect of the invention, a use of a flat-filter filter element in a filter system, for filtering a fluid, for example for filtering air, for example for an air filter system of a fuel cell system, is proposed.

Beneficially, the filter element may be configured as particle filter and/or as adsorption filter, for example as active carbon filter and/or as ion exchanger. Particles as well as harmful gases may be filtered out of the intake air in fuel cell systems, for example.

### BRIEF DESCRIPTION OF THE DRAWINGS

Further advantages result from the following drawing description. In the drawings, embodiments of the invention are illustrated. The drawings and the following detailed description contain numerous features in combination. A person of skill in the art will consider the features expediently also individually and combine them to expedient further combinations.

FIG. 1 shows an isometric view of a filter system for filtering a fluid, for example for filtering air, for example of a fuel cell system, according to an embodiment of the invention.

FIG. 2 shows an isometric exploded illustration of the filter system according to FIG. 1.

FIG. 3 shows an isometric view of a filter element according to a further embodiment of the invention.

FIG. 4 shows a longitudinal section of a filter element according to a further embodiment of the invention with a marked detail V.

FIG. 5 shows the enlarged detail V according to FIG. 4.

FIG. 6 shows an enlarged detail of a section view of a filter element according to a further embodiment of the invention.

### DETAILED DESCRIPTION

In the drawing figures, same or same-type components are identified with like reference characters. The drawing figures show only examples and are not to be understood as limiting.

Directional terminology used in the following with terms such as “left”, “right”, “top”, “bottom”, “in front of”, “behind”, “thereafter” and the like serve only for a better understanding of the drawing figures and is not at all meant to represent a limitation of the generality. The illustrated components and elements, their interpretation and use may vary in the context of considerations of a person of skill in the art and be adapted to the respective applications.

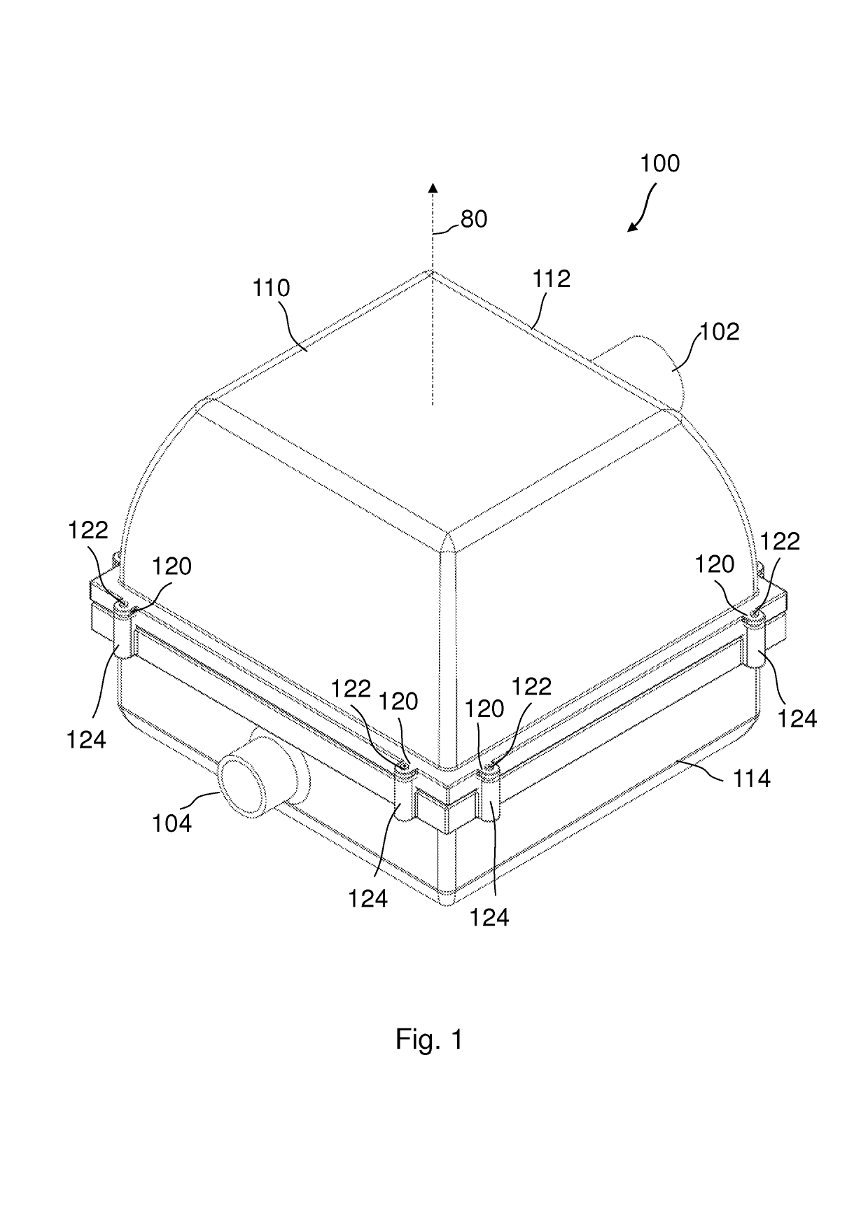

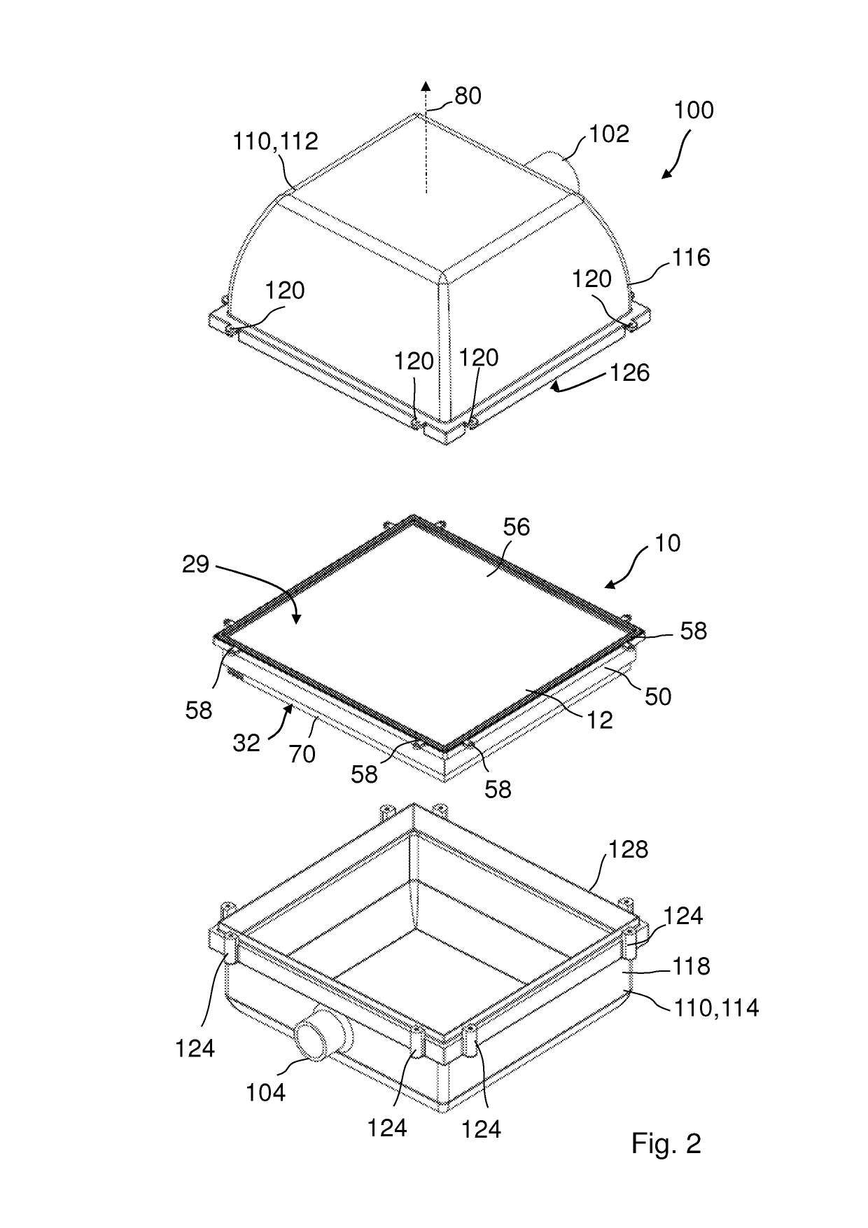

FIG. 1 shows an isometric view of a filter system 100 for filtering a fluid, for example for filtering air, for example of a fuel cell system, according to an embodiment of the invention. FIG. 2 shows an isometric exploded view of the filter system 100.

The filter system 100 comprises a filter housing 110 with a fluid inlet 102 and a fluid outlet 104 and comprises at least one flat-filter filter element 10 which is arranged between the fluid inlet 102 and the fluid outlet 104. The fluid inlet 102 is arranged in a first housing part 112 and the fluid outlet 104 in a second housing part 114.

The filter element 10 of the embodiments illustrated in the drawing figures comprises respectively a circumferential frame element 50, with a circumferential molded element 20 configured as an axial seal element. In an embodiment, not illustrated, the filter element 10 may be configured however also without frame element 50, only with the molded element 20.

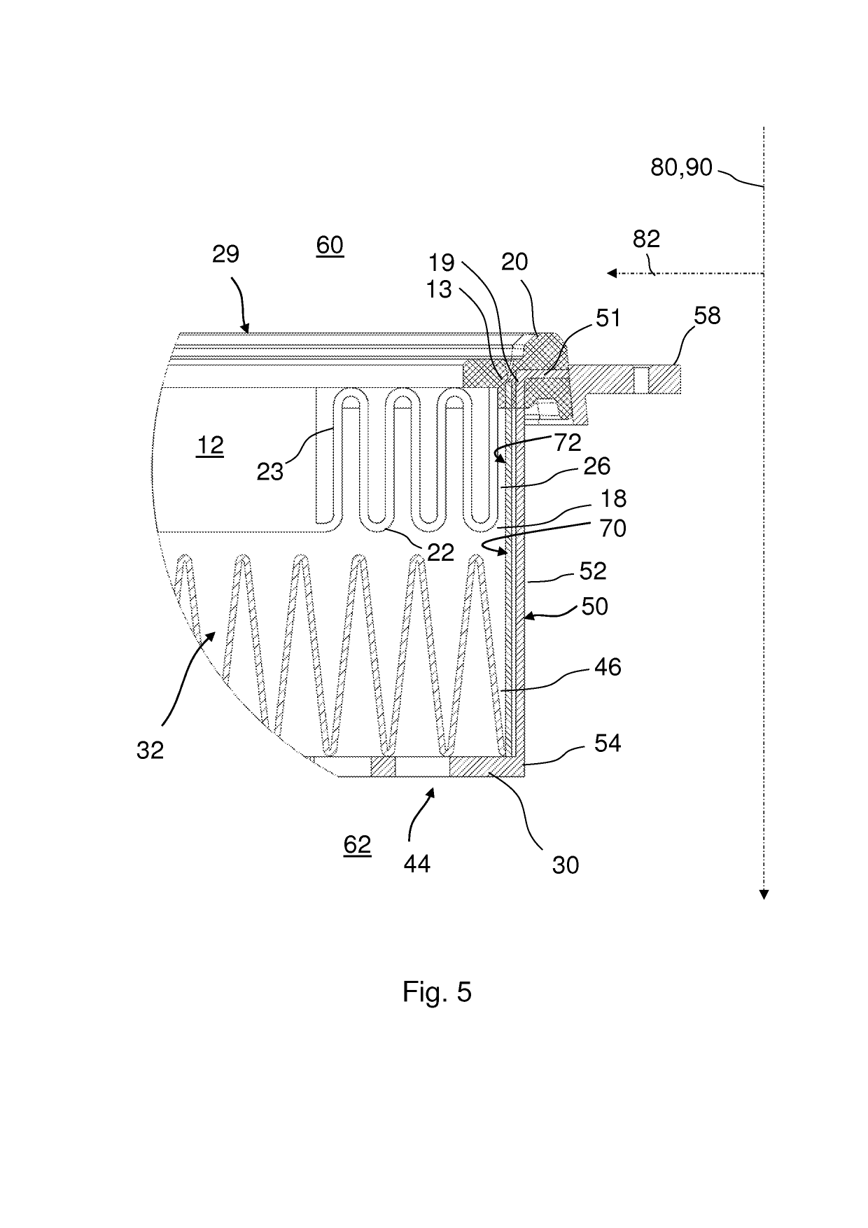

The molded element 20 seals the interior of the filter housing 110 in relation to the environment when the filter element 10 is arranged as intended in the second housing part 114 and filter housing 110 is closed by the first housing part 112. At the same time, the molded element 20 seals a raw side 60 in the interior of the filter housing 110 in relation to a clean side 62 (FIG. 5).

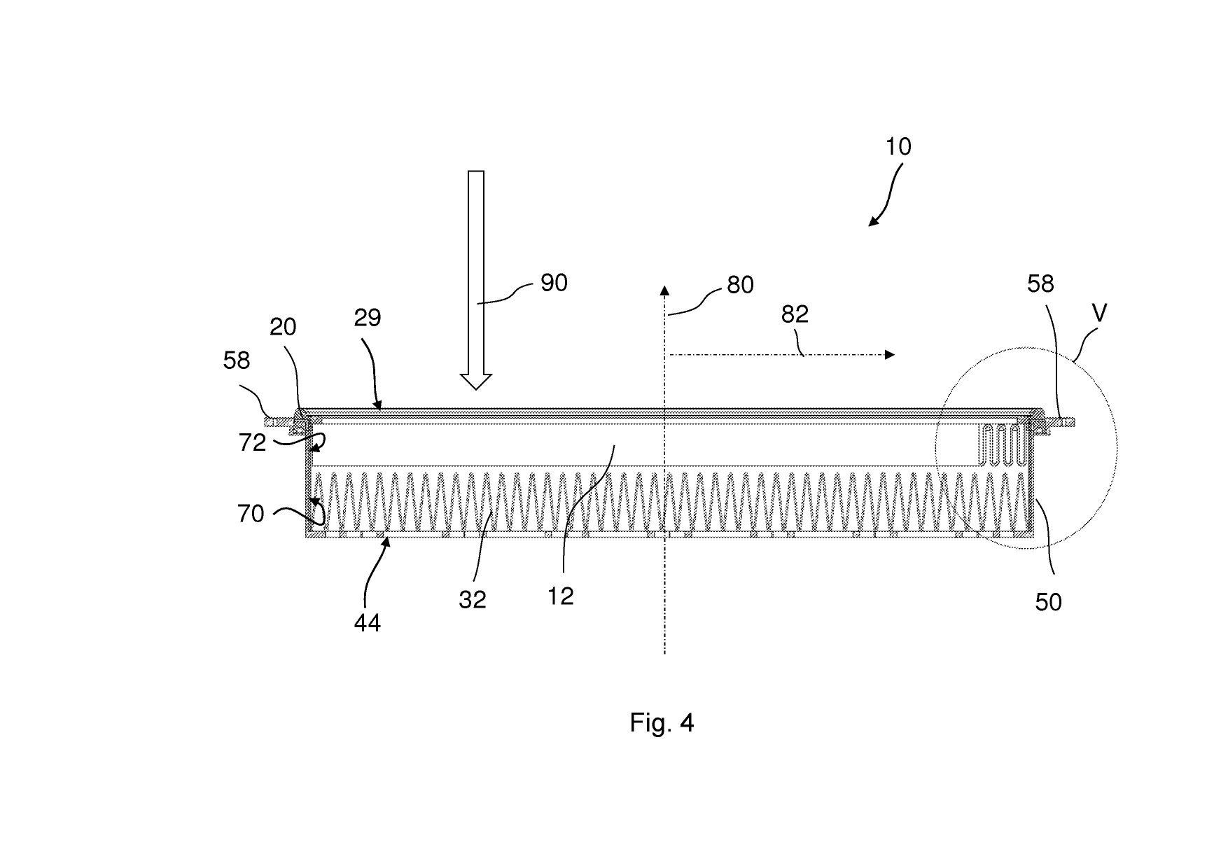

The inflow side 29 of the filter element 10 is oriented in the direction of the fluid inlet 102 toward the first housing part 112. The fluid enters the filter element 10 from the inflow side 29 and exits the filter element 10 at the outflow side 44 (FIG. 4).

When the filter element 10 is inserted, screw tabs 58 of the frame element 50 of the filter element 10 are arranged between screw sleeves 124 and screw tabs 120 of the housing wall 116 of the first housing part 112 and fastened by screws 122, as seen in FIG. 1.

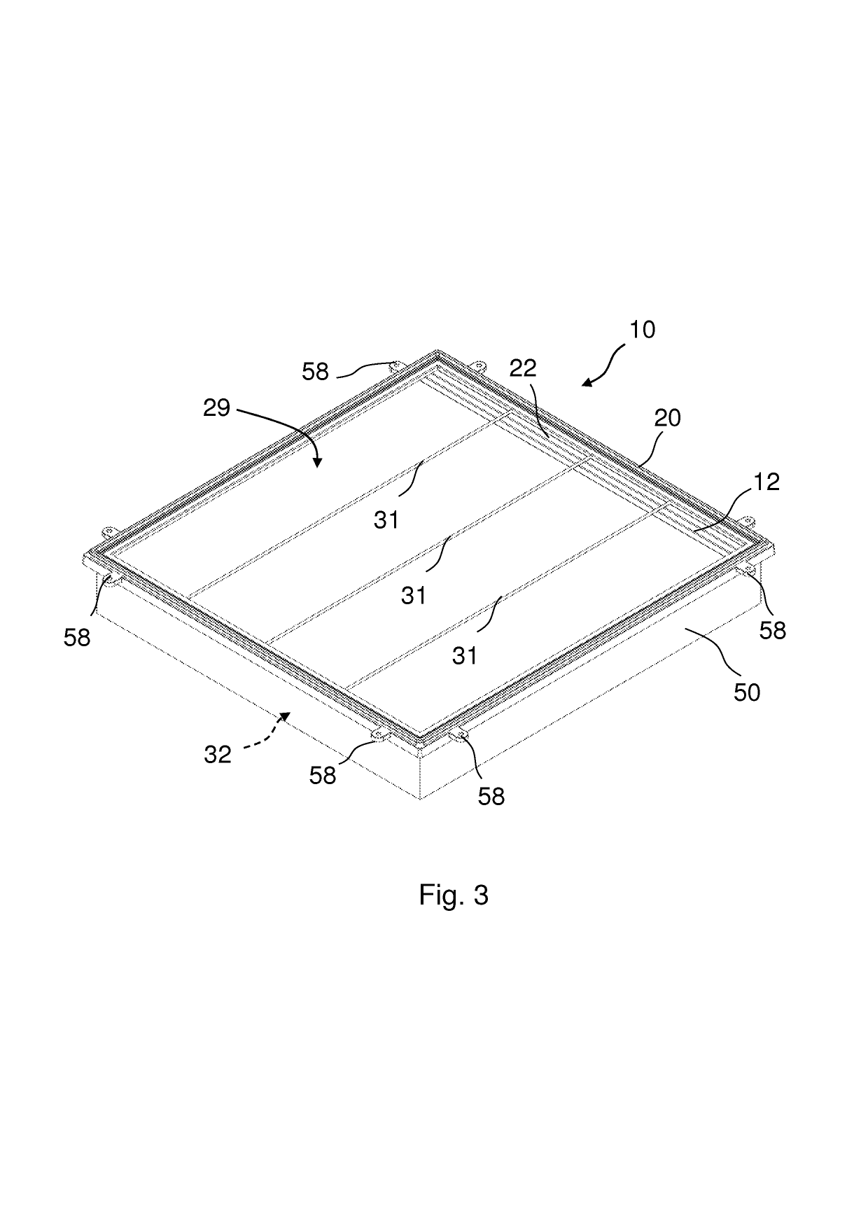

FIG. 3 shows an isometric view of a filter element 10 according to a further embodiment of the invention. In this filter element 10, glue beads 31 are arranged transversely to the folds 22 of the upstream filter medium body 12 at the inflow side 29 for stiffening and stabilizing the folds 22.

FIG. 4 shows a longitudinal section of a filter element 10 according to another embodiment of the invention with a marked detail V. FIG. 5 shows the enlarged detail V according to FIG. 4.

The flat-filter filter element 10 comprises an arrangement of at least two areal filter medium bodies 12, 32 neighboring each other and arranged one after another in an axial direction 80. The two filter medium bodies 12, 32 are arranged so as to be flowed through by the fluid sequentially in the axial direction 80. The flow direction 90 is marked by an arrow in FIG. 4.

The upstream filter medium body 12 is configured as a particle filter while the downstream filter medium body 32 is configured as an adsorption filter.

The filter medium bodies 12, 32 may be configured, for example, as folded filter bellows and/or as wound body and/or as loose fill and/or as coated honeycomb body. The particle filter in this context may be configured, for example, of cellulose, the adsorption filter, for example, as active carbon filter and/or as ion exchanger. In the embodiment illustrated in FIGS. 4 and 5, both filter medium bodies 12, 32 are configured as folded filter bellows.

The filter medium bodies 12, 32 at their respective outer circumference 26, 46 are framed by a common circumferential lateral strip 70. The common lateral strip 70 extends with a protrusion section 72 from the downstream filter medium body 32 in axial direction 80 to the upstream filter medium body 12. In this context, the common lateral strip 70 is embedded at the outermost upstream filter medium body 12 in the circumferential molded element 20.

The lateral strip 70, for example, may be configured of a nonwoven material, for example a filter nonwoven, filter fabric or laid filter material. The nonwoven material of the lateral strip 70 may comprise for example a reduced air permeability compared to a filter medium of the filter medium body 12 and/or a higher bending stiffness compared to a filter medium of the filter medium body 12.

The common lateral strip 70 extends up to an upstream end 13 of the upstream filter medium body 12 and is at least partially embedded in the molded element 20.

The upstream filter medium body 12 is also embedded at its upstream end 13 in the molded element 20.

Furthermore, the two filter medium bodies 12, 32 are arranged at least partially in axial direction 80 radially inside of a circumferential frame element 50. In this context, the upstream filter medium body 12, by means of the circumferential molded element 20, is connected to the frame element 50 at one of its outer edges 18, 19, namely its upstream outer edge 19.

The frame element 50 comprises at its upstream end of a wall 52 a collar 51 which extends in a lateral direction 82 and is folded outwardly and is embedded in the molded element 20. The collar 51 with the molded element 20, when the filter element 10 is mounted as intended in the filter housing 110, is compressed between a seal surface 126 of the first housing part 112 (FIG. 2) and an end 128 of a housing wall 118 of the second housing part 114 (FIG. 2).

The frame element 50 is configured like a pot. At its downstream axial end 54, a reinforcement element 30 in the form of a reinforcement grid forms a bottom of the pot-like frame element 50. The two filter medium bodies 12, 32 are thus received in the pot-like frame element 50 with their entire height. In this way, the entire filter element 10 achieves a sufficient stiffness, even in case of very large surface area filter medium bodies 12, 32. For example, the frame element 50 and the reinforcement element 30 may be configured as one piece, whereby even greater stability of the filter element 10 may be achieved.

The frame element 50, at least in the region of the molded element 20, may have furthermore gaps in its circumference for interlocking with the molding material of the molded element 20.

The molded element 20 serves as an axial seal element for sealing between the raw side 60 and the clean side 62 when the filter element 10 is installed as intended in the filter housing 110. The molded element 20 is arranged radially outside of the two filter medium bodies 12, 32 and seals at the same time between the first housing part 112 and a second housing part 114 of the filter housing 110. The seal surface 126 of the first housing part 112 (FIG. 2) contacts the molded element 20, and the housing wall 118 of the second housing part 114 (FIG. 2) is seal-tightly pressed against the molded element 20 at a side of the molded element facing away from the seal surface 126. In this way, an advantageous sealing action may be achieved by means of the molded element 20.

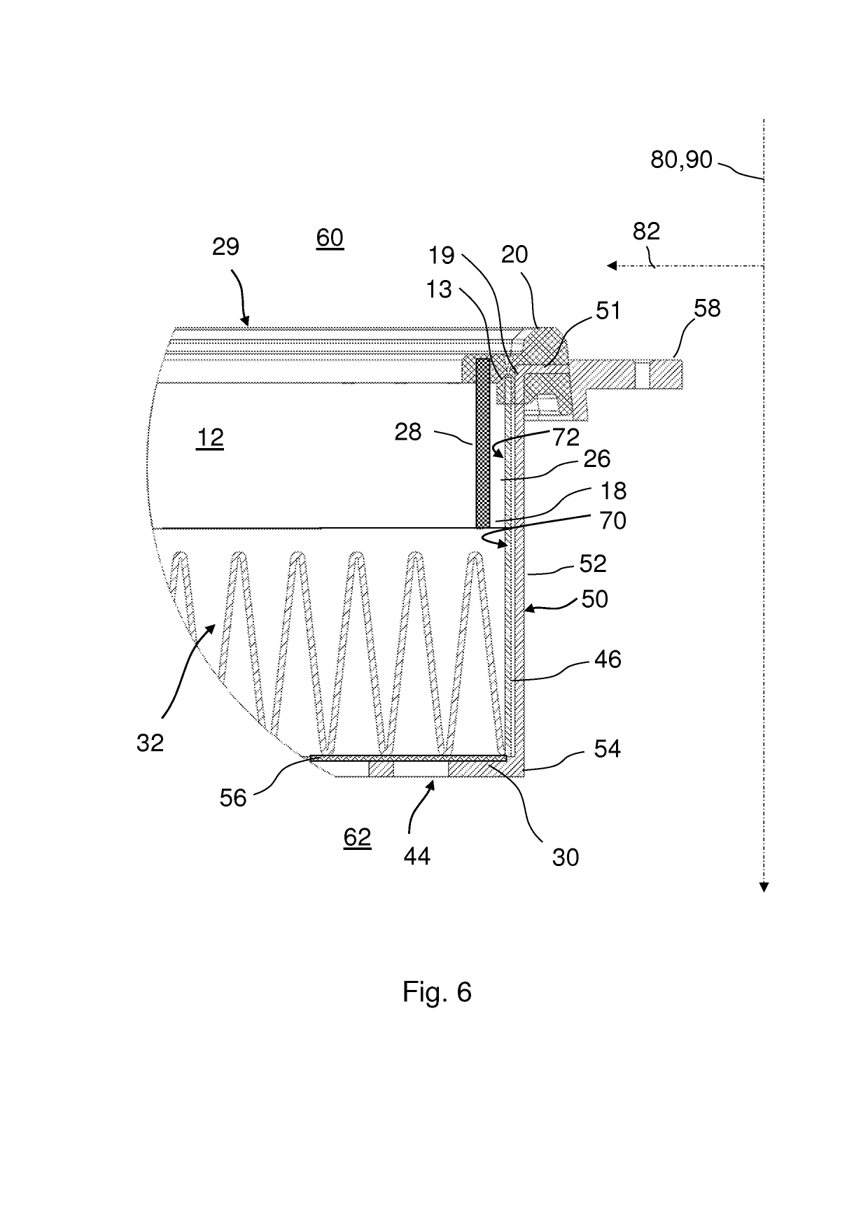

FIG. 6 shows an enlarged detail of a section view of a filter element 10 according to a further embodiment of the invention.

Both filter medium bodies 12, 32 are configured as folded filter bellows. In the illustrated embodiment, end face edges 23 of the folds 22 (FIG. 5) of the upstream filter medium body 12 are sealed by an end face edge bonding 28 in this context. The individual folds 22 of the filter medium body 12 cannot be seen in this illustration because they extend perpendicularly to the image plane. The end face edge bonding 28 at the outer edge 18 of the filter medium body 12 is at least partially embedded in the upstream molded element 20.

In this embodiment, the downstream filter medium body 32 comprises an additional filter layer 56 at its outflow side 44. In this way, for example an escape of adsorption particles from the downstream filter medium body 32 due to the fluid flow may be prevented. As embodiments for the additional filter layer 56, filter media on the basis of cellulose fibers and/or synthetic fibers, for example nonwoven materials and/or filter membranes, are conceivable.

An additional filter layer 56 could also be applied to a different type of downstream filter medium body 32, for example, embodied as wound body, loose fill or coated honeycomb body.

### Reference Characters

10 filter element

12 upstream filter medium body

13 upstream end

18 downstream outer edge

19 upstream outer edge

20 molded element

22 fold

23 end face edge

26 outer circumference

28 end face edge bonding

29 inflow side

30 reinforcement grid

31 glue bead

32 downstream filter medium body

44 outflow side

46 outer circumference

50 frame element

51 collar

52 wall

54 axial end

56 filter layer

58 screw tab

60 raw side

62 clean side

70 common lateral strip

72 protrusion section

80 axial direction

82 lateral direction

90 flow direction

100 filter system

102 fluid inlet

104 fluid outlet

110 filter housing

112 first housing part

114 second housing part

116 housing wall

118 housing wall

120 screw tab

122 screw

124 screw sleeve

126 seal surface

128 end

That which is claimed is:

1. A flat-filter filter element for filtering a fluid, the flat-filter filter element comprising:
at least two areal filter medium bodies arranged in an axial direction adjacent to each other and arranged to be flowed through by the fluid sequentially in the axial direction, wherein the at least two areal filter medium bodies each have an outer circumference;
a common circumferential lateral strip arranged to frame the at least two areal filter medium bodies at their respective outer circumference;
wherein the at least two areal filter medium bodies include a downstream filter medium body and an upstream filter medium body;
wherein the common circumferential lateral strip comprises a protrusion section that extends from the downstream filter medium body in the axial direction to the upstream filter medium body;
a circumferential molded element arranged at the upstream filter medium body;
wherein the common circumferential lateral strip is embedded at least partially in the circumferential molded element arranged at the upstream filter medium body.

2. The flat-filter filter element according to claim 1, wherein the common circumferential lateral strip extends up to an upstream end of the upstream filter medium body and is embedded at the upstream end in the circumferential molded element.

3. The flat-filter filter element according to claim 2, wherein the upstream filter medium body is embedded at the upstream end in the circumferential molded element.

4. The flat-filter filter element according to claim 1, further comprising a circumferential frame element, wherein at least the downstream filter medium body and at least the upstream filter medium body are arranged at least partially in the axial direction radially inside of the circumferential frame element.

5. The flat-filter filter element according to claim 4, wherein the upstream filter medium body comprises outer edges and is connected at one of the outer edges to the circumferential frame element by the circumferential molded element.

6. The flat-filter filter element according to claim 5, wherein the outer edges include an upstream outer edge, wherein the upstream filter medium body is connected at the upstream outer edge to the circumferential frame element.

7. The flat-filter filter element according to claim 4, wherein the circumferential frame element comprises an outwardly folded collar arranged at an upstream end of the circumferential frame element.

8. The flat-filter filter element according to claim 7, wherein the outwardly folded collar of the circumferential frame element is embedded in the circumferential molded element.

9. The flat-filter filter element according to claim 4, further comprising a reinforcement element arranged at a downstream end of the circumferential frame element to form a pot-shaped structure, wherein the reinforcement element forms a bottom of the pot-shaped structure, and wherein the reinforcement element is a reinforcement grid.

10. The flat-filter filter element according to claim 9, wherein the reinforcement element and the circumferential frame element are formed together as one piece.

11. The flat-filter filter element according to claim 4, wherein a circumference of the circumferential frame element, at least in a region of the circumferential molded element, comprises gaps configured to interlock with the circumferential molded element.

12. The flat-filter filter element according to claim 1, wherein the downstream filter medium body comprises an additional filter layer arranged at an outflow side of the downstream filter medium body.

13. The flat-filter filter element according to claim 1, wherein the upstream filter medium body is a particle filter and/or wherein the downstream filter medium body is an adsorption filter.

14. The flat-filter filter element according to claim 1, wherein the circumferential molded element is configured as a seal element configured to seal between a raw side and a clean side when the flat-filter filter element is installed in a filter housing.

15. The flat-filter filter element according to claim 14, wherein the circumferential molded element is arranged radially outside of the at least two filter medium bodies and is configured to seal between a first housing part and a second housing part of the filter housing.

16. The flat-filter filter element according to claim 1, wherein at least one of the at least two filter medium bodies is a folded filter bellows comprising folds, wherein end face edges of the folds of the at least one of the at least two filter medium bodies are sealed by an end face edge bonding, and wherein the end face edge bonding is embedded at least partially in the circumferential molded element.

17. A filter system for filtering a fluid, the filter system comprising:
a filter housing comprising a fluid inlet and a fluid outlet,
at least one flat-filter filter element according to claim 1, arranged between the fluid inlet and the fluid outlet;
wherein the filter housing further comprises a first housing part and a second housing part:
wherein a seal surface of the first housing part contacts the circumferential molded element of the at least one flat-filter filter element; and
wherein a housing wall of the second housing part is pressed seal-tightly against the circumferential molded element of the at least one flat-filter filter element at a side of the circumferential molded element facing away from the seal surface.

18. The filter system according to claim 17, wherein the at least one flat-filter filter element comprises a circumferential frame element comprising a collar, wherein the collar extends in a lateral direction and is embedded in the circumferential molded element of the at least one flat-filter filter element, and wherein the circumferential molded element of the at least one flat-filter filter element together with the collar embedded therein is compressed between the seal surface of the first housing part and an end of the housing wall of the second housing part.

19. The filter system according to claim 17, wherein the filter system is an air filter system of a fuel cell system.
